(19) United States
(12) Patent Application Publication
(10) Pub. No.: US 2012/0192127 A1
(43) Pub. Date: Jul. 26, 2012

(54) METHOD OF MANUFACTURING SEMICONDUCTOR DEVICE

(75) Inventors: Satoshi USUI, Oita-ken (JP); Ryuji OGAWA, Kanagawa-ken (JP); Yuji KODAMA, Saitama-ken (JP); Shigeki NOJIMA, Kanagawa-ken (JP); Shigeru HASEBE, Oita-ken (JP); Seiji ISHITANI, Oita-ken (JP)

(73) Assignee: KABUSHIKI KAISHA TOSHIBA, Tokyo (JP)

(21) Appl. No.: 13/357,263

(22) Filed: Jan. 24, 2012

(30) Foreign Application Priority Data
Jan. 25, 2011 (JP) 2011-013070

(51) Int. Cl. G06F 17/50

(52) U.S. Cl. 716/55

(57) ABSTRACT

A space area is extracted from a product area on which element patterns are laid out and a mark region is extracted from the space area in the product area under a predetermined condition. The product area is divided into multiple regions and a monitor pattern forming region is selected from the mark regions for each divided region under a predetermined condition. A monitor pattern is laid out within the selected monitor pattern forming region.

### CROSS REFERENCE TO RELATED APPLICATIONS

This application is based upon and claims the benefit of priority from the prior Japanese Patent Application No. 2011-013070 filed in Japan on Jan. 25, 2011; the entire contents of which are incorporated herein by reference.

### FIELD

Embodiments described herein relate generally to a method of laying out patterns on an exposure mask for use in manufacturing semiconductor devices.

### BACKGROUND

Embodiments of the present invention relate to a method of laying out patterns on an exposure mask for use in manufacturing semiconductor devices.

In recent years, the further scale-down of integrated circuit patterns formed on semiconductor devices is in demand. This necessitates the more rigorous, precise control of the sizes, shapes, etc. of circuit patterns formed on wafers, that is, the quality control of the finished products.

Typically, in order to control the finished products, particularly, the sizes, shapes, etc. of circuit patterns formed on wafers, or to control the circuit patterns, particularly, the misalignment of the circuit patterns, control patterns that are laid out on dicing lines located outside product areas are used. However, the control patterns formed on the dicing lines have coverage rate, layouts, etc. that differ from those of patterns formed within product areas. Accordingly, it is difficult to monitor the patterns formed within the product areas precisely.

An object of embodiments of the present invention is to provide a method of laying out patterns on an exposure mask, which enables the precise pass/failure determination of exposure masks or the precise optimization of conditions for semiconductor manufacturing process.

### BRIEF DESCRIPTION OF THE DRAWINGS

FIG. 1 is a flowchart of a method of laying out patterns on an exposure mask according to an embodiment of the present invention.

FIG. 2 is a view depicting an example of the layout of products on an one-shot area according to the embodiment.

FIG. 3 is a partially enlarged view showing an example of a space area according to the embodiment.

FIG. 4 is a view showing an example of divided production areas according to the embodiment.

FIG. 5 is a view showing an example of a process of selecting monitor pattern forming regions according to the embodiment.

FIG. 6 is a partially enlarged view showing an example of the layout of a monitor pattern according to the embodiment.

FIG. 7 is a partially enlarged view showing an example of the layout of monitor patterns according to the embodiment.

FIG. 8 is a partially enlarged view showing another example of the layout of products on an one-shot area according to the embodiment.

### DETAILED DESCRIPTION

Embodiments of the present invention provide a method of laying out patterns on an exposure mask. This method of laying out patterns on an exposure mask includes the steps of extracting a space area from a product area on which element patterns are laid out, extracting mark regions from the space area under a predetermined condition, dividing the product area into a plurality of regions, and selecting a monitor pattern forming region from the mark regions for each of the divided regions under a predetermined condition, and laying out a monitor pattern within the monitor pattern forming region.

A description will be given below of a method of laying out patterns on an exposure mask according to this embodiment with reference to the accompanying drawings.

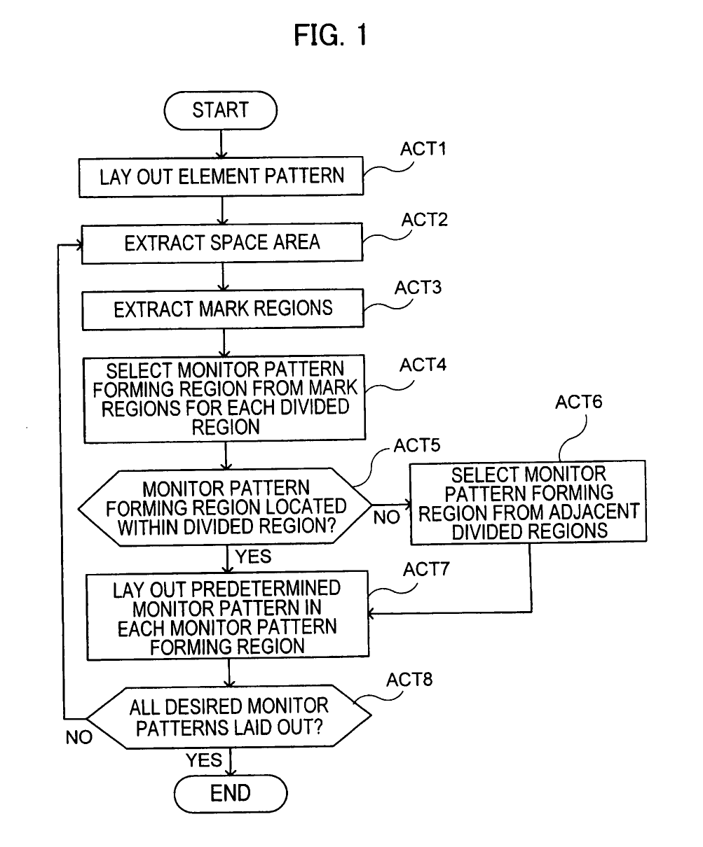

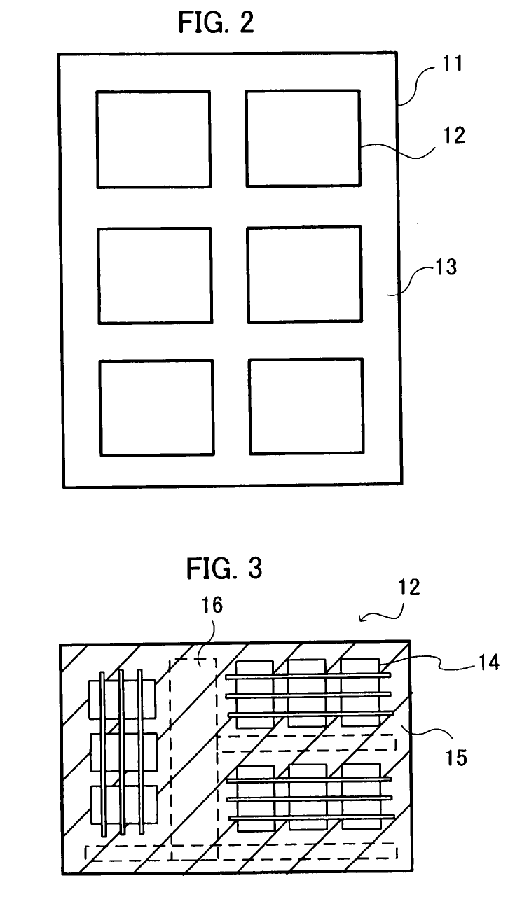

FIG. 1 is a flowchart of a method of laying out patterns on an exposure mask according to the embodiment. First, on an exposure mask of this embodiment, multiple product areas 12 (chips) are arranged on an one-shot area 11, while being separated from one another by a dicing line 13, for example, as shown in FIG. 2. This one-shot area 11 corresponds to an area to be exposed for one exposure step. On the product areas (chips) 12 arranged in this manner, element patterns 14, such as C-MOS transistors, are laid out, as shown in FIG. 3 (Act 1).

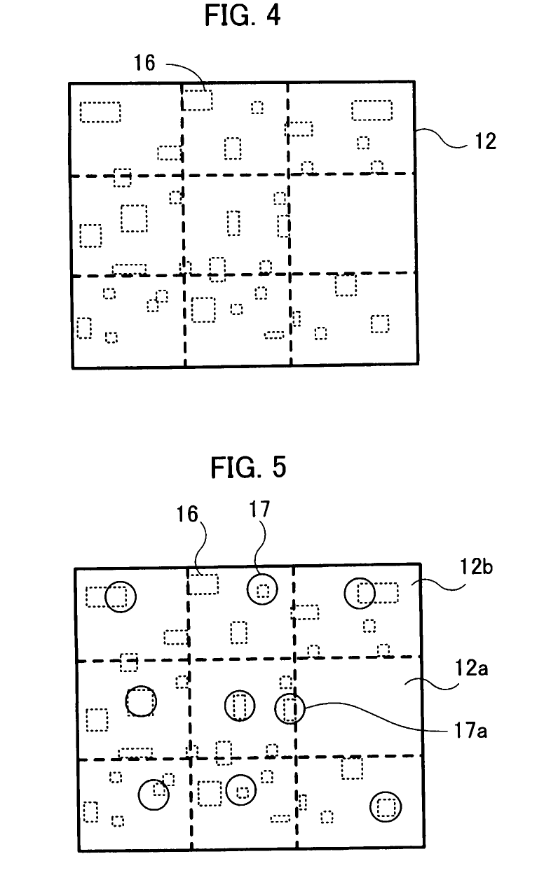

Then, referring to a partially enlarged view of the product area 12 in FIG. 3, a space area 15 (indicated by shaded lines) that corresponds to a portion of each product area 12 where no element patterns 14 are formed is extracted (Act 2). Subsequently, a mark region 16 (surrounded by a dashed line) is extracted under the condition of being located away from the element patterns 14 by a predetermined distance or longer (Act 3). On this mark region 16, a monitor pattern is to be laid out, as will be described later. Accordingly, the mark region 16 has a shape and area to be able to contain a necessary monitor pattern formed thereon, and is set at a location away from the element patterns 14 by a predetermined distance or longer in order to counteract the influence which a monitor pattern exerts upon the property of the element patterns. FIG. 4 shows multiple mark regions 16 set on the single product area (chip) 12 in the abovementioned manner.

Then, the single product area 12 is divided equally into, for example, nine regions arrayed in a matrix of three rows and three columns, as shown in FIG. 4, and a monitor pattern forming region 17 (surrounded by circular lines), on which a monitor pattern is to be formed, is selected from the multiple mark regions 16 for each divided region, as shown in FIG. 5 (Act 4).

Specifically, among the multiple mark regions contained in each divided region, one which satisfies a condition of, for example, being located near the center of the divided region is selected as the monitor pattern forming region 17. In this case, if the mark region 16 is located at the center of the divided region, then this mark region 16 is selected as the monitor pattern forming region 17. Otherwise, if no mark regions 16 are located at the center of the divided region, then the mark region 16 located nearest the center of the divided region is selected as the monitor pattern forming region 17.

Then, it is determined whether or not the monitor pattern forming region 17 has been located within each divided region (Act 5). As for the divided region 12a containing no mark regions 16, a mark region 16 located in one of divided regions adjacent to the divided region 12a which is located nearest the center of the divided region 12a, that is, a mark region 16 located in a divided region 12b is selected as the monitor pattern forming region 17a (Act 6).

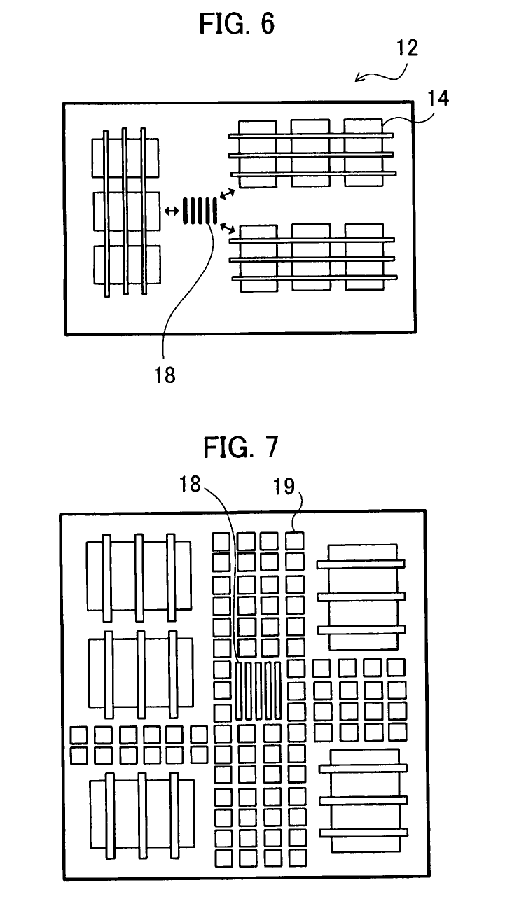

Then, monitor patterns 18 having a predetermined pattern are laid out in the corresponding selected monitor pattern forming regions 17 (Act 7). In this case, each monitor pattern 18 is preferably positioned so as to be away from surrounding elements by the same direction, as in the partially enlarged product area 12 shown in FIG. 6. This layout allows the influence which the monitor patterns 18 exert upon the property of the elements to be restricted to the same level.

In addition, after the monitor pattern 18 is laid out, dummy patterns having a square, rectangle or some other shape may be laid out for the purpose of adjusting the coverage. In this case, it is preferable that dummy patterns 19 be laid out on the space area 15 surrounding the monitor pattern 18, for example, as shown in FIG. 7. By laying out the dummy patterns 19 around the monitor pattern 18 as described above, the coverage of the product area can be made further uniform. This makes it possible to restrict the positional dependence of the shapes and sizes of the element patterns during the manufacturing process.

Finally, it is determined whether or not all desired monitor patterns 18 have been laid out on the divided regions of the product area 12 (Act 8). If all the monitor patterns 18 have been laid out, then this process is terminated. Otherwise, if there is any desired monitor pattern that has not yet been laid out, then a space area 15 is extracted again (Act 2), and then, monitor patterns are laid out as well.

The monitor patterns laid out in this manner are used as finished product quality control patterns for controlling the sizes, shapes, etc. of patterns, for example, upon pass/failure determination of masks before shipment or optimization of process conditions.

Furthermore, these monitor patterns may be, for example, element patterns. For example, the monitor patterns may be patterns having the minimum pitch formed by Min DR Pitch, patterns formed by the layout widely applied to the elements, memory patterns such as SRAM applied to the elements, or the like.

Moreover, the size of the monitor patterns may be, for example, 1 μm to 10 μm per side, preferably, 2 μm to 5 μm per side.

The monitor patterns may be used as not only finished product quality control patterns, but also misalignment measurement patterns for measuring and controlling the misalignment, film thickness measurement patterns for measuring the film thickness, and the like. These patterns may be used either independently or together with the finished product quality control patterns.

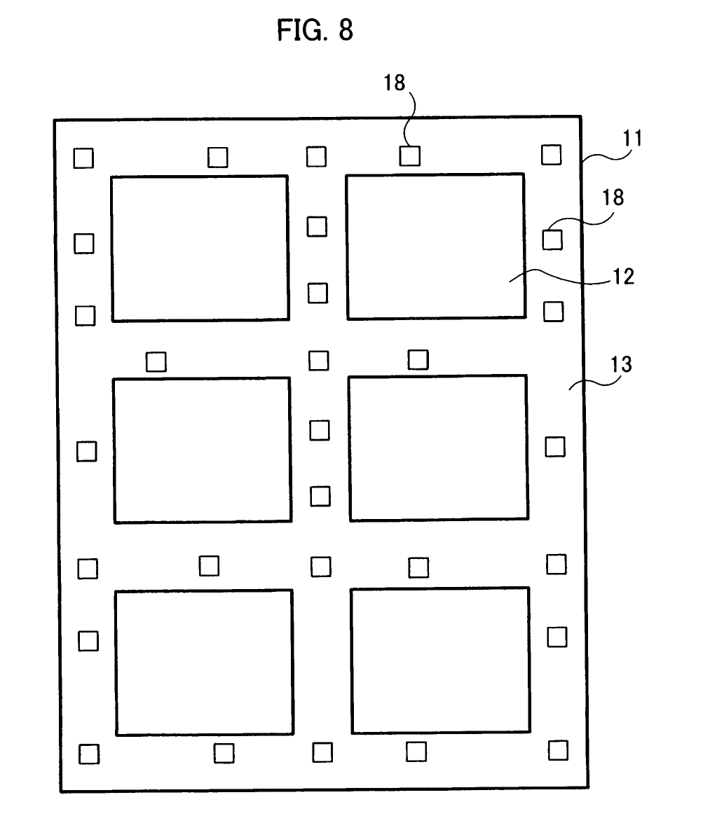

It is preferable that the monitor patterns 18 be formed not only on the product area, but also on the dicing line 13, as shown in FIG. 8. When the monitor patterns 18 are formed on the dicing line 13 in addition to the product area 12, many more monitor patterns 18 can be laid out within the one-shot area (on one mask). This enables the more precise control of quality of finished products, the sizes of elements, and the like.

This embodiment has been described for the case where the product area 12 is divided into the nine regions, and the monitor patterns 18 are laid out on each divided region. However, this is merely an example for the explanation. Alternatively, it is preferable that twenty-five or more divided regions, namely, regions arrayed in a matrix of five or more rows and five or more columns be used when a single chip is manufactured by an one-shot exposure process. Specifically, it is preferable that twenty-five or more monitor patterns 18 be arranged on the one-shot area (or a mask), and the preferable number of divided regions in the product area 12 be varied depending on the structure of a chip as indicated in the above description. When the product area 12 is divided in the above mentioned manner and the monitor pattern 18 is laid out on each divided region, the monitor patterns are laid out more randomly and evenly. In addition, when the monitor patterns having the above layout are used, it is possible to monitor the patterns on the product area more precisely, thereby attaining the more precise control of quality of the finished products, the sizes of elements, and the like.

Furthermore, it is more preferable that one monitor pattern 18 be laid out on each divided region, and total twenty-five or more monitor patterns 18 be laid out within the one-shot area 11. This layout enables more precise control of quality of the finished products, the sizes of elements, and the like.

According to the method of laying out patterns on an exposure mask of at least one embodiment described above, basically, the monitor pattern is laid out on each of regions formed by dividing the product area, so that the monitor patterns are arranged on the product area more randomly and evenly. Furthermore, using these arranged monitor patterns enables the more precise pass/failure determination of exposure masks and the more precise optimization of conditions for a semiconductor manufacturing process.

It should be noted that although some embodiments of the present invention have been described, these embodiments are simply examples, and do not intend to limit the scope of the invention.

The abovementioned embodiments can be implemented by other various embodiments, and various omissions, modifications and variations may be applied to the present invention without departing from the spirit of the invention.

The embodiments and variations thereof should be contained in the spirit of the invention, as well as in the scope of the invention recited in the claims and equivalents thereof.

What is claimed is:

1. A method of laying out a pattern on an exposure mask, comprising:
laying out and forming an element pattern on one of a plurality of product areas formed on an one-shot area, the product areas being separated from one another by a dicing line;
extracting a space area from the product area on which the element pattern is formed, the space area being an area on which the element pattern is not formed;
extracting a plurality of mark regions located away from the element pattern by a predetermined distance or longer from the space area;
dividing the product area into a plurality of regions and selecting, as a monitor pattern forming region, one of the mark regions contained in each divided region which is located substantially at a center of the divided region; and
laying out a monitor pattern within the monitor pattern forming region.

2. The method of laying out a pattern on an exposure mask according to claim 1, wherein the predetermined distance corresponds to a distance substantially preventing the monitor pattern from affecting an operation of the element pattern.

3. The method of laying out a pattern on an exposure mask according to claim 1, wherein the divided regions are formed by equally dividing the product area.

4. The method of laying out a pattern on an exposure mask according to claim 1, wherein the monitor pattern includes a pattern used in the element.

5. A method of laying out a pattern on an exposure mask according to claim 1, further comprising, if the mark region is not contained in the divided region, the step of selecting, as the monitor pattern forming region, one of the mark regions contained in divided regions adjacent to the divided region which is located near the center of each of the divided regions.

6. The method of laying out a pattern on an exposure mask according to claim 1, further comprising the step of laying out, around the monitor pattern, a dummy pattern for adjusting coverage.

7. A method of determining shipment of an exposure mask, comprising the step of determining whether or not an exposure mask is failed by making a size measurement using the monitor pattern laid out by the method of laying out a pattern on an exposure mask according to any of claims 1 to 6.

8. A method of forming a circuit pattern, comprising the step of optimizing a condition for a semiconductor manufacturing process by using the monitor pattern laid out by the method of laying out a pattern on an exposure mask according to any of claims 1 to 3.
